(19) United States
(12) Patent Application Publication
(10) Pub. No.: US 2025/0196700 A1
(43) Pub. Date: Jun. 19, 2025

(54) Controller, Server, Control System, and Control Method

(71) Applicant: TOYOTA JIDOSHA KABUSHIKI KAISHA, Toyota-shi Aichi-ken (JP)

(72) Inventor: Junichi NISHIDA, Miyoshi-shi Aichi-ken (JP)

(73) Assignee: TOYOTA JIDOSHA KABUSHIKI KAISHA, Toyota-shi Aichi-ken (JP)

(21) Appl. No.: 18/976,780

(22) Filed: Dec. 11, 2024

(30) Foreign Application Priority Data
Dec. 14, 2023 (JP) 2023-211290

(51) Int. Cl. B60L 53/68; B60L 53/65; B60L 53/66

(52) U.S. Cl. CPC B60L 53/68; B60L 53/65; B60L 53/66; B60L 2240/54

(57) ABSTRACT

A controller comprises a DCM and a processor. The DCM sends a battery pack ID to a battery information server, and receives from the battery information server a charging/discharging parameter conforming to a battery pack corresponding to the battery pack ID. The processor uses the received charging/discharging parameter to control charging and discharging the battery pack.

### CROSS REFERENCE TO RELATED APPLICATIONS

This nonprovisional application is based on Japanese Patent Application No. 2023-211290 filed on Dec. 14, 2023 with the Japan Patent Office, the entire contents of which are hereby incorporated by reference.

### BACKGROUND

### Field

The present disclosure relates to a controller, a server, a control system, and a control method.

### Description of the Background Art

Japanese Patent Laying-Open No. 2015-104225 discloses a charging device to charge a secondary battery. The charging device comprises a table storage unit that stores a table indicating a correspondence between a combination of a temperature of the secondary battery and a direct-current resistance of the secondary battery and a charging condition, a temperature detection unit that detects the temperature of the secondary battery, and a resistance detection unit that detects the direct-current resistance of the secondary battery. The charging device charges the secondary battery according to a charging condition corresponding to the detected temperature and direct-current resistance.

### SUMMARY

In the charging device described in Japanese Patent Laying-Open No. 2015-104225, a charging condition for the secondary battery is selected based on the secondary battery's detected temperature and direct-current resistance values. In that case, when the temperature detection unit or the resistance detection unit has an error, the secondary battery cannot be charged (or power transmission cannot be done) under an appropriate charging condition.

The present disclosure has been made to address the above issue, and contemplates a controller, a server, a control system, and a control method capable of preventing power transmission performed under an inappropriate condition for a battery mounted on a vehicle.

A controller according to a first aspect of the present disclosure is a controller that controls power transmission including at least one of charging a battery and discharging the battery, comprising: a communication unit for the controller, that communicates with an external device; and a processor that performs a process to obtain identification information of the battery. The external device includes an external server that stores parameter information for a parameter for the power transmission conforming to the battery corresponding to the identification information. The processor obtains the parameter information conforming to the battery corresponding to the identification information from the external server through the communication unit for the controller. The controller uses the parameter information obtained by the processor to control the power transmission for the battery.

As described above, the controller according to the first aspect of the present disclosure receives the parameter information conforming to the battery corresponding to the identification information from the external server, and uses the received parameter information to control the power transmission for the battery. This can prevent parameter information that does not conform to the battery from being used in the power transmission. As a result, power transmission performed for the battery under an inappropriate condition can be prevented.

For the controller according to the first aspect, the battery includes a battery using, as an active material, lithium manganese iron phosphate produced by recycling lithium-iron phosphate having been used as an active material. The parameter information includes information of a parameter used in the power transmission, that is preset based on a ratio between manganese and iron in the active material. Note that a lithium manganese iron phosphate ion battery has a capacity (a charge-discharge capacity) varying with a ratio between manganese and iron. Accordingly, using parameter information preset based on the ratio to perform power transmission allows the power transmission to be performed under a more appropriate condition. The above ratio of a recycled product varies more than that of a new product. Therefore, using parameter information based on the above ratio in power transmission for the recycled product is particularly effective for optimizing a condition in the power transmission.

In that case, the parameter information includes information of the parameter preset based on the ratio and an amount of impurities contained in the battery. Note that a lithium manganese iron phosphate ion battery also has a capacity (a charge-discharge capacity) varying with an amount of impurities contained. Therefore, using parameter information preset based on an amount of impurities in addition to the ratio to perform power transmission allows the power transmission to be performed under a further more appropriate condition.

The controller according to the first aspect is mounted on a vehicle. Further, the processor performs the process to obtain the identification information when the vehicle has an ignition power supply turned on. This configuration allows a parameter for power transmission to be optimized whenever the ignition power supply is turned on. For example, the ignition power supply is turned off while a battery is replaced with another. Thus, an optimum parameter can be obtained at a time when the ignition power supply is turned on after the battery replacement is completed.

The controller according to the first aspect is mounted on a vehicle. When the processor is connected to a terminal connectable to the vehicle, and receives a signal from the terminal to request the identification information, the processor responsively performs the process to obtain the identification information. This configuration allows the identification information to be obtained in response to a signal received from the external device. As a result, the identification information can be easily sent to the external device in response to the request.

For the controller according to the first aspect, when the identification information obtained is changed identification information, the communication unit for the controller sends the changed identification information to the external server. This configuration allows a parameter corresponding to another battery pack to be obtained whenever a battery pack is replaced with the other battery pack.

A server according to a second aspect of the present disclosure is a server provided outside the controller according to the first aspect. The server comprises: a communication unit for the server, that receives identification information of the battery; and a storage unit that stores parameter information for a parameter for the power transmission conforming to the battery corresponding to the identification information. The communication unit for the server sends to the controller the parameter information conforming to the battery corresponding to the identification information received.

As described above, the server according to the second aspect of the present disclosure sends the parameter information conforming to the battery corresponding to the identification information to the controller through the communication unit for the server. Thus, a server capable of preventing the controller to perform power transmission for a battery under an inappropriate condition, can be provided.

A control system according to a third aspect of the present disclosure comprises the controller according to the first aspect and the server according to the second aspect. Thus, a control system capable of preventing the controller to perform power transmission for a battery under an inappropriate condition, can be provided.

A control method according to a fourth aspect of the present disclosure is a control method of a controller for controlling power transmission including at least one of charging a battery and discharging the battery, comprising: obtaining identification information of the battery; receiving from an external server that stores parameter information for a parameter for the power transmission conforming to the battery corresponding to the identification information the parameter information conforming to the battery corresponding to the identification information; and controlling the power transmission for the battery using the parameter information received.

As described above, the control method according to the fourth aspect of the present disclosure receives from the external server the parameter information conforming to the battery corresponding to the identification information, and uses the received parameter information to control the power transmission for the battery. Thus, a control method capable of preventing power transmission performed for a battery under an inappropriate condition can be provided.

In the control method according to the fourth aspect, the battery includes a battery using, as an active material, lithium manganese iron phosphate produced by recycling lithium-iron phosphate having been used as an active material. The parameter information includes information of a parameter used in the power transmission, that is preset based on a ratio between manganese and iron in the active material. Thus, a control method that is particularly effective for optimizing a condition in power transmission, can be provided.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows a configuration of a control system according to a first embodiment.

FIG. 2 indicates information stored in a memory of a battery information server according to the first embodiment;

FIG. 3 is a graph representing a relationship between charge-discharge capacity and potential of each of an LFP battery and an LMFP battery.

FIG. 4 is a graph representing relationships between charge-discharge capacity and a number of charge-discharge cycles for different ratios of manganese to iron for an LMFP battery.

FIG. 5 is a diagram for illustrating a sequence of control of a control system according to the first embodiment.

FIG. 6 shows a configuration of a control system according to a second embodiment.

FIG. 7 is a diagram for illustrating a sequence of control of the control system according to the second embodiment.

### DESCRIPTION OF THE EMBODIMENTS

The present disclosure will now be described in embodiments hereinafter in detail with reference to the drawings. In the figures, identical or equivalent components are identically denoted and will not be described repeatedly.

### First Embodiment

### <Configuration of Control System>

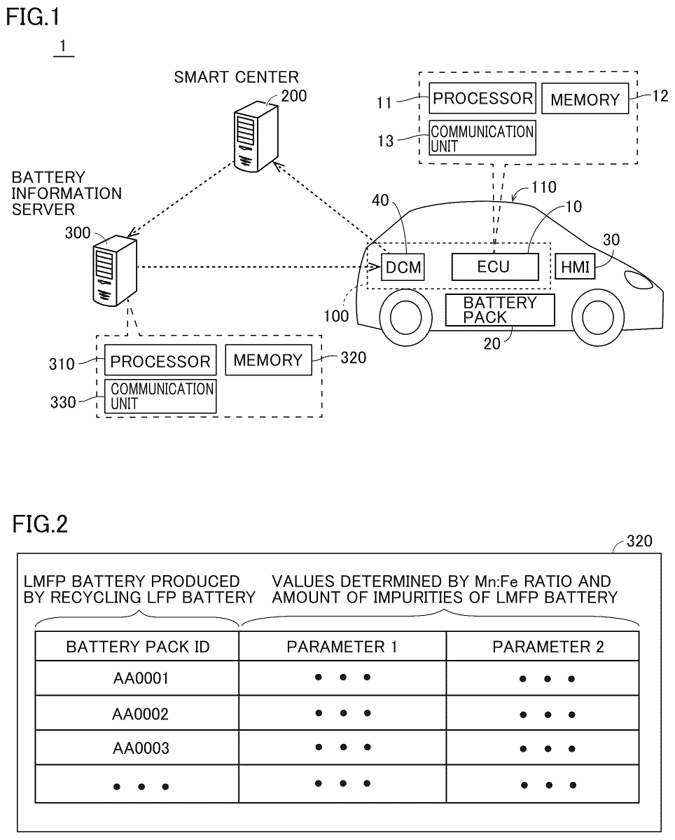

FIG. 1 shows a configuration of a control system 1 according to a first embodiment. Control system 1 comprises a controller 100, a smart center 200, and a battery information server 300. Smart center 200 is an example of an “external device” of the present disclosure. Battery information server 300 is an example of the “external device,” an “external server,” and a “server” of the present disclosure.

Controller 100 is mounted on an electric vehicle 110. Smart center 200 and battery information server 300 are devices provided outside electric vehicle 110. Electric vehicle 110 for example includes a PHEV (Plug-in Hybrid Electric Vehicle), a BEV (Battery Electric Vehicle), or an FCEV (Fuel Cell Electric Vehicle). Electric vehicle 110 is an example of a “vehicle” in the present disclosure.

In addition to controller 100, electric vehicle 110 comprises a battery pack 20 and an HMI (human machine interface) device 30. Controller 100 includes an ECU (electronic control unit) 10 and a DCM (data communication module) 40. Battery pack 20 and DCM 40 are an example of a “battery” and a “communication unit for the controller,” respectively, in the present disclosure.

Battery pack 20 stores electric power for driving electric vehicle 110. Battery pack 20 accommodates a plurality of battery cells. Battery pack 20 is provided in electric vehicle 110 so as to be replaceable with another battery pack in a battery exchange device, by a dealer, or the like (not shown). Battery pack 20 can have the battery cells electrically connected to electric vehicle supply equipment or the like (not shown) to be chargeable and rechargeable. Charging and discharging are each an example of “power transmission” in the present disclosure.

Battery pack 20 includes an LMFP (lithium manganese iron phosphate) battery, for example. Battery pack 20 that is an LMFP battery is produced by recycling an LFP (lithium-iron phosphate) battery, for example. Specifically, the LMFP battery includes a battery using, as an active material, lithium manganese iron phosphate produced by recycling lithium-iron phosphate having been used as an active material in an LFP battery. Battery pack 20 is not limited in configuration (or material) to the above example. For example, battery pack 20 may include an LFP battery or a ternary battery.

HMI device 30 for example includes a display terminal such as a car navigation system. HMI device 30 causes the display terminal to display predetermined information (maps, video contents, a variety of types of alerts, etc.).

DCM 40 is configured to be capable of communicating with smart center 200 and battery information server 300. Electric vehicle 110 can thus communicate a variety of types of information with smart center 200 and battery information server 300 through DCM 40.

ECU 10 includes a processor 11, a memory 12, and a communication unit 13. Memory 12 stores a program executed by processor 11 and, in addition, information used in the program (e.g., a map, a mathematical expression, and a variety of types of parameters). Further, processor 11 performs a process to obtain a variety of types of information (for example, a battery pack ID described later) through communication unit 13.

Communication unit 13 is configured to be capable of CAN (Controller Area Network) communication with a variety of types of ECUs (not shown) provided in electric vehicle 110. For example, communication unit 13 performs CAN communication with an ECU (a battery computer) provided for battery pack 20 to obtain ID information of battery pack 20 (hereinafter referred to as a battery pack ID). The battery pack ID is recorded in a memory (not shown) or the like for battery pack 20. The battery pack ID is an example of “identification information” in the present disclosure.

Battery information server 300 includes a processor 310, a memory 320, and a communication unit 330. Memory 320 stores a program executed by processor 310 and, in addition, information used in the program (e.g., a map, a mathematical expression, and a variety of types of parameters). Memory 320 and communication unit 330 are an example of a “storage unit” and a “communication unit for a server,” respectively, in the present disclosure.

Specifically, memory 320 stores a parameter for charging and discharging (hereinafter referred to as a charging/discharging parameter) conforming to each of a plurality of battery packs registered with battery information server 300. Memory 320 stores the battery pack ID of each battery pack and a charging/discharging parameter (a parameter 1 and a parameter 2) in association with each other. The charging/discharging parameter for example includes information such as a charge/discharge voltage, a charge/discharge current (a charge/discharge rate), and a threshold used for temperature management and current (voltage) management for a battery. The charging/discharging parameter is an example of “parameter information” in the present disclosure.

The charging/discharging parameter is a value determined through an inspection conducted when manufacturing the battery pack (through a recycling process). Specifically, a ratio between manganese (Mn) and iron (Fe) in an active material in an LMFP battery produced by recycling an LFP battery is managed in battery information server 300. Battery information server 300 also manages amounts of impurities and additives contained in the LMFP battery. The charging/discharging parameter is a value determined for each LMFP battery based on the ratio, the amount of impurities, etc., of the LMFP battery. The charging/discharging parameter may be determined for each manufacturing lot of the battery pack or for each vehicle type.

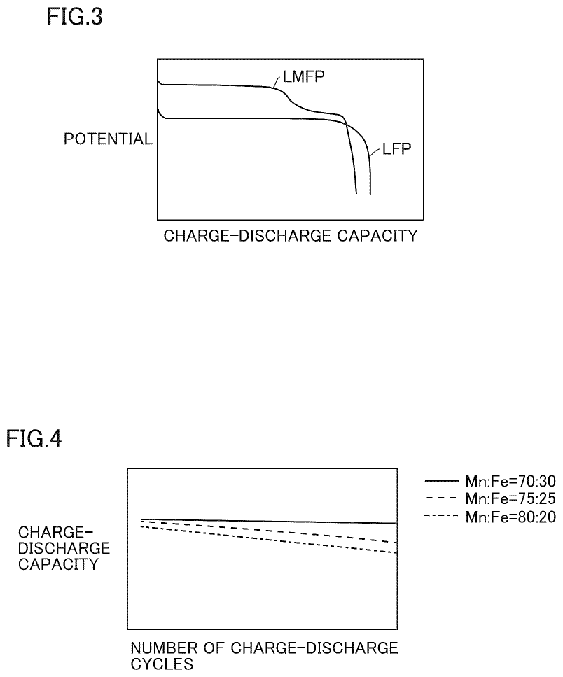

Note that while an electric vehicle has a battery pack replaced with another battery pack, a charging/discharging parameter conforming to the replaced battery pack may be continuously used. In that case, the replacement battery pack is charged/discharged while the charging/discharging parameter that does not conform thereto is used. As a result, for example, the replacement battery pack is not charged/discharged within an appropriate voltage range and hence smoothly. For example, as shown in FIG. 3, an LFP battery has a relationship between potential (operating potential) and charge-discharge capacity, and an LMFP battery has a different relationship therebetween. Specifically, the LMFP battery is higher in potential than the LFP battery.

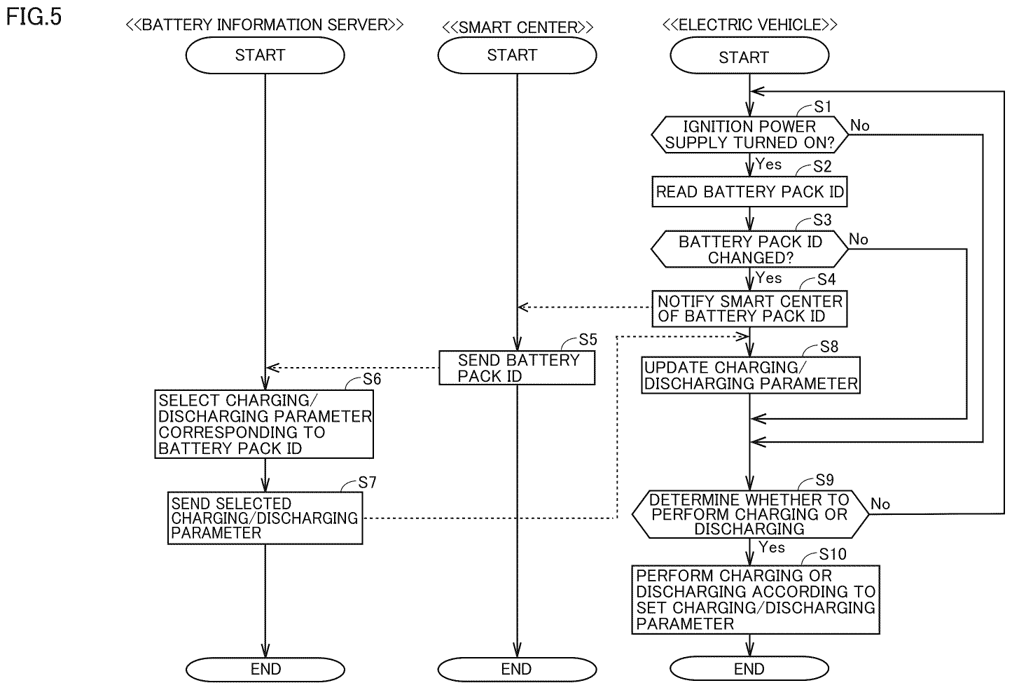

Further, LMFP batteries having different ratios between manganese and iron, different amounts of impurities, etc., also have different relationships between potential (operating potential) and charge-discharge capacity. FIG. 4 is a graph representing relationships between charge-discharge capacity and a number of charge-discharge cycles for different ratios between manganese and iron. FIG. 4 shows that an LMFP battery having a manganese to iron ratio of 70:30 has a less degraded charge-discharge capacity with respect to a number of charge-discharge cycles than LMFP batteries having such ratios of 75:25 and 80:20. The LMFP battery having such a ratio of 75:25 has a less degraded charge-discharge capacity with respect to the number of charge-discharge cycles than LMFP battery having such a ratio of 80:20.

Accordingly, in the first embodiment, DCM 40 of electric vehicle 110 sends a battery pack ID obtained by communication unit 13 to battery information server 300. Processor 11 obtains from battery information server 300 through DCM 40 a charging/discharging parameter conforming to battery pack 20 corresponding to the battery pack ID. Controller 100 (ECU 10) controls charging and discharging battery pack 20 using the charging/discharging parameter obtained by processor 11. Details will be described with reference to a sequence diagram shown in FIG. 5.

### <Control Method in Control System>

FIG. 5 is a sequence diagram for illustrating control between battery information server 300, smart center 200, and electric vehicle 110 (controller 100) in control system 1. Each control of battery information server 300 in FIG. 5 is executed by processor 310. Each control of electric vehicle 110 in FIG. 5 is executed by controller 100 (ECU 10 (processor 11)).

In step S1, electric vehicle 110 determines whether electric vehicle 110 has an ignition power supply turned on. That is, electric vehicle 110 determines whether the ignition power supply is turned on by a user operating an operation button of the ignition power supply. When the ignition power supply is turned on (Yes in S1), the process proceeds to step S2. When the ignition power supply is not turned on (No in S1), the process proceeds to step S9.

In step S2, electric vehicle 110 performs the step of obtaining (or reading) the battery pack ID of battery pack 20 through communication unit 13 through CAN communication. Specifically, communication unit 13 receives information of the battery pack ID from a battery computer of battery pack 20 through CAN communication.

In step S3, electric vehicle 110 determines whether the battery pack ID has changed. Specifically, electric vehicle 110 determines whether the battery pack ID read in S2 is different from the battery pack ID read last time. If the battery pack ID has changed (Yes in S3), the process proceeds to step S4. When the battery pack ID has not changed (No in S3), the process proceeds to step S9.

In step S4, electric vehicle 110 sends the information of the battery pack ID read in step S2 to smart center 200 through DCM 40.

In step S5, smart center 200 sends to battery information server 300 the information of the battery pack ID sent from electric vehicle 110 in step S4.

In step S6, battery information server 300 selects, based on information (see FIG. 2) stored in memory 320, a charging/discharging parameter corresponding to the battery pack ID sent from smart center 200 in step S5.

In step S7, battery information server 300 sends information of the charging/discharging parameter selected in step S6 to electric vehicle 110 (DCM 40) through communication unit 330. Note that the information of the charging/discharging parameter may be sent to electric vehicle 110 via smart center 200.

In step S8, electric vehicle 110 updates (or changes) the currently set charging/discharging parameter to the charging/discharging parameter sent from battery information server 300 in step S7.

In step S9, electric vehicle 110 determines whether to perform charging or discharging. For example, electric vehicle 110 determines to perform charging or discharging in response to a command received from the user to perform charging or discharging or in response to a charging/discharging connector being connected to electric vehicle 110, etc. When charging or discharging is performed (Yes in S9), the process proceeds to step S10. When charging or discharging is not performed (No in S9), the process returns to step S1.

In step S10, electric vehicle 110 performs charging or discharging according to the set charging/discharging parameter. Specifically, when the step S8 is performed, electric vehicle 110 performs charging or discharging using the updated charging/discharging parameter. On the other hand, when the step S8 is not performed, electric vehicle 110 performs charging or discharging using the current charging/discharging parameter (held at the time of step S1). Thereafter, the process ends.

Thus, in the first embodiment, electric vehicle 110 sends an obtained battery pack ID to battery information server 300, and receives from battery information server 300 information of a charging/discharging parameter conforming to battery pack 20 corresponding to the battery pack ID. Electric vehicle 110 controls charging or discharging battery pack 20 using the received information of the charging/discharging parameter. Even when battery pack 20 is changed in type due to battery replacement or the like, charging and discharging can be performed using a charging/discharging parameter conforming to the changed type of battery pack 20. As a result, battery pack 20 can be charged and discharged appropriately (e.g., efficiently).

### Second Embodiment

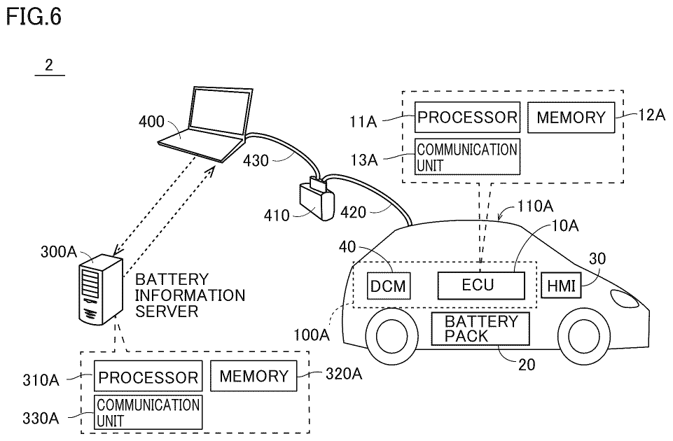

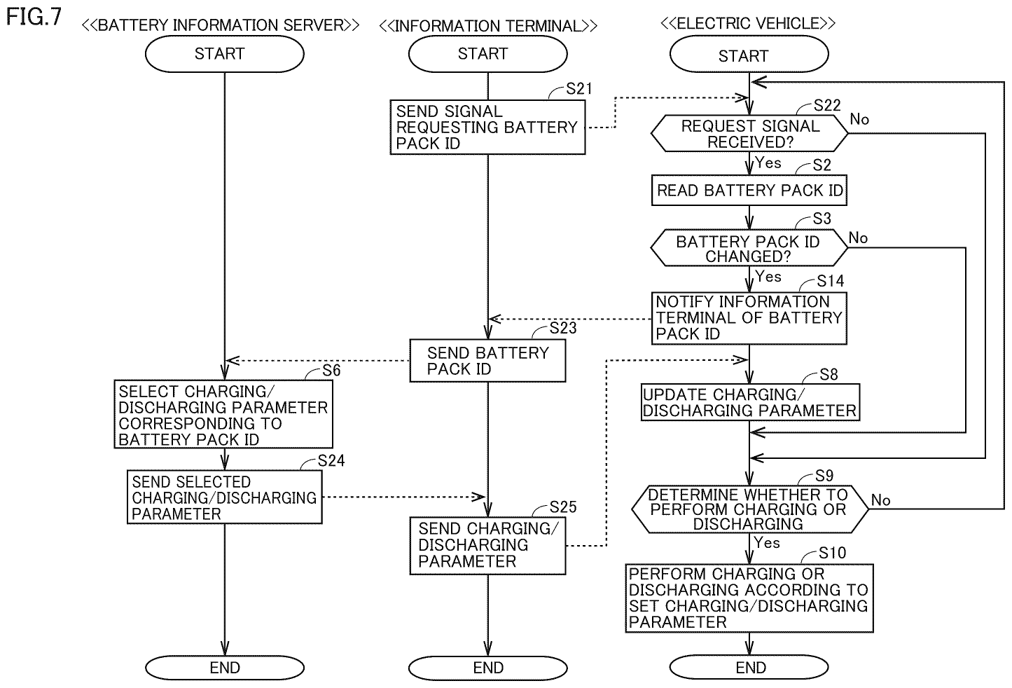

A second embodiment of the present disclosure will now be described with reference to FIGS. 6 and 7. In the second embodiment, in contrast to the first embodiment, in which information of a battery pack ID and a charging/discharging parameter is communicated through communications through DCM 40, the information is communicated through an information terminal 400 provided in a facility of a dealer or the like. Note that components identical to those of the first embodiment are identically denoted and will not be described repeatedly.

### <Configuration of Control System>

FIG. 6 shows a configuration of a control system 2 according to the second embodiment. Control system 2 comprises a controller 100A, information terminal 400, a diagnosis tool 410, and a battery information server 300A. Information terminal 400 is connectable to electric vehicle 110A via diagnosis tool 410. Diagnosis tool 410 is an example of the “external device” of the present disclosure. Information terminal 400 is an example of the “external device” and a “terminal” of the present disclosure. Battery information server 300A is an example of the “external server,” the “external device,” and the “server” of the present disclosure.

Controller 100A is mounted on electric vehicle 110A. Information terminal 400 and diagnosis tool 410 are devices provided outside electric vehicle 110A. Electric vehicle 110A is different from electric vehicle 110 of the first embodiment in that the former is provided with controller 100A rather than controller 100. Controller 100A may not be provided with DCM 40. Electric vehicle 110A is an example of the “vehicle” in the present disclosure.

Controller 100A includes an ECU 10A. ECU 10A includes a processor 11A, a memory 12A, and a communication unit 13A. Memory 12A stores a program executed by processor 11A and, in addition, information used in the program (e.g., a map, a mathematical expression, and a variety of types of parameters). Communication unit 13A is an example of the “communication unit for the controller” in the present disclosure.

Battery information server 300A includes a processor 310A, a memory 320A, and a communication unit 330A. Memory 320A stores a program executed by processor 310A and, in addition, information used in the program (e.g., a map, a mathematical expression, and a variety of types of parameters). Memory 320A and communication unit 330A are an example of the “storage unit” and the “communication unit for a server,” respectively, in the present disclosure.

As well as memory 320 of the first embodiment (see FIG. 2), memory 320A stores battery pack IDs and charging/discharging parameters in association with one another.

Information terminal 400 and diagnosis tool 410 are devices provided for a dealer, a vehicle repair plant, a battery replacement facility, etc. Diagnosis tool 410 is connected to electric vehicle 110A by a cable 420 to diagnose whether electric vehicle 110A has an error. In doing so, diagnosis tool 410 extracts information of a battery pack ID from electric vehicle 110A. Note that when connected to information terminal 400 (or diagnostic tool 410), electric vehicle 110A (or processor 11A) performs a process to obtain a battery pack ID in response to a signal received from information terminal 400 requesting the battery pack ID. Information of the battery pack ID extracted by diagnosis tool 410 is transmitted to information terminal 400 connected to diagnosis tool 410 by a cable 430. The information of the battery pack ID obtained by information terminal 400 is communicated and thus sent to battery information server 300A. Note that information terminal 400 and electric vehicle 110A (communication unit 13A) communicate information therebetween through CAN communication.

### <Control Method in Control System>

FIG. 7 is a sequence diagram for illustrating control between battery information server 300, information terminal 400, and electric vehicle 110A in control system 2. Each control of battery information server 300A in FIG. 7 is executed by processor 310A. Each control of electric vehicle 110A in FIG. 7 is executed by controller 100A (ECU 10A (processor 11A)). Note that steps similar to those in the sequence according to the first embodiment (see FIG. 5) are identically denoted will not be described repeatedly.

In step S21, information terminal 400 sends a signal requesting information of a battery pack ID to electric vehicle 110A via diagnosis tool 410. The signal requesting the battery pack ID may be directly sent from information terminal 400 to electric vehicle 110A without passing through diagnosis tool 410.

In step S22, electric vehicle 110A determines whether the request signal in step S21 is received. When the request signal is received (Yes in S22), the process proceeds to step S2. When the request signal is not received (No in S22), the process proceeds to step S9.

For Yes in step S3, a step S14 is performed. In step S14, electric vehicle 110A sends to (or notifies) information terminal 400 (of) the information of the battery pack ID through communication unit 13A via diagnosis tool 410. The information of the battery pack ID may be directly sent from electric vehicle 110A to information terminal 400 without passing through diagnosis tool 410.

In step S23, information terminal 400 sends the information of the battery pack ID sent from electric vehicle 110A in step S14 to battery information server 300A.

In step S24, battery information server 300A sends the information of the charging/discharging parameter selected in step S6 to information terminal 400 through communication unit 330. Note that the information of the charging/discharging parameter may be directly sent to electric vehicle 110A.

In step S25, information terminal 400 sends the information of the charging/discharging parameter sent from battery information server 300A in step S24 to electric vehicle 110A via diagnosis tool 410. Note that the information of the charging/discharging parameter may be directly sent from information terminal 400 to electric vehicle 110A without passing through diagnosis tool 410. Furthermore, the information of the charging/discharging parameter may be directly sent from battery information server 300A (communication unit 330A) to electric vehicle 110A (DCM 40). Thereafter, step S8, step S9, and step S10 are performed in electric vehicle 110A.

The remainder in configuration and processing is similar to that of the first embodiment, and accordingly will not be described repeatedly.

While in the first and second embodiments an example has been described in which each battery pack 20 is provided with an ID, the present disclosure is not limited thereto. For example, a plurality of battery cells accommodated in a battery pack may each be provided with an ID. In that case, a process for updating a charging/discharging parameter may be performed when each of the plurality of battery cells is replaced.

While in the first and second embodiments an example has been described in which a charging/discharging parameter based on a ratio between manganese and iron and an amount of impurities in battery pack 20 is stored in battery information server 300A (300A), the present disclosure is not limited thereto. A charging/discharging parameter predetermined based on only one of the ratio and the amount may be stored in battery information server 300 (300A).

While in the first and second embodiments an example has been described in which controller 100 (100A) is mounted on electric vehicle 110 (110A), the present disclosure is not limited thereto. For example, the controller may be provided in electric vehicle supply equipment (EVSE) where an electric vehicle is charged therefrom (discharged thereto).

While in the first and second embodiments an example has been described in which electric vehicle 110 (110A) performs a process to obtain (or read) a battery pack ID when an ignition power supply is turned on or when a request signal is received from information terminal 400, the present disclosure is not limited thereto. For example, the electric vehicle may perform the process to obtain (or read) the battery pack ID in response to a battery pack replacement process being performed. In that case, a default value (or an initial value) used to determine whether the battery is deteriorated is reviewed (optimized) through battery replacement, which can suppress reduction in accuracy in determining whether the battery is deteriorated.

While in the first and second embodiments an example has been described in which control system 1(2) comprises smart center 200 and battery information server 300 (300A), the present disclosure is not limited thereto. The control system may comprise a single server having smart center 200 and battery information server 300 (300A) integrated together.

While in the first and second embodiments an example has been described in which electric vehicle 110 (110A) is capable of performing each of charging and discharging, the present disclosure is not limited thereto. For example, the electric vehicle may only be capable of performing charging.

While in the first embodiment an example has been described in which a battery pack ID and information of a charging/discharging parameter are sent and received between DCM 40 of electric vehicle 110 and battery information server 300, the present disclosure is not limited thereto. At least one of the battery pack ID and the information of the charging/discharging parameter may be sent and received between battery information server 300 and a terminal (a smartphone or the like) of a user.

While in the second embodiment an example has been described in which information terminal 400 and electric vehicle 110A are connected via diagnosis tool 410, the present disclosure is not limited thereto. Information terminal 400 and electric vehicle 110A may be directly connected to each other.

While in the first and second embodiments an example has been described in which an LMFP battery produced by recycling an LFP battery is mounted on electric vehicle 110 (110A), the present disclosure is not limited thereto. For example, an LFP battery which is not a recycled product or an LMFP battery which is not a recycled product may be mounted on electric vehicle 110 (110A), or a new LFP battery produced by recycling an LFP battery may be mounted thereon.

While in the first and second embodiments an example has been described in which battery pack 20 is mounted on electric vehicle 110 (110A), the present disclosure is not limited thereto. The battery pack may be mounted on an electric device (for example, a stationary power storage device) other than an electric vehicle.

Note that the controls described in the first embodiment, the second embodiment, and a variety of types of modifications described above may be executed in combination with one another.

Although the embodiments of the present disclosure have been described, it should be considered that the embodiments disclosed herein are illustrative and non-restrictive in every respect. The scope of the present disclosure is defined by the terms of the claims, and is intended to encompass any modifications within the scope and meaning equivalent to the terms of the claims.

What is claimed is:

1. A controller that controls power transmission including at least one of charging a battery and discharging the battery, comprising:
a communication unit for the controller, that communicates with an external device; and
a processor that performs a process to obtain identification information of the battery, wherein
the external device includes an external server that stores parameter information for a parameter for the power transmission conforming to the battery corresponding to the identification information,
the processor obtains the parameter information conforming to the battery corresponding to the identification information from the external server through the communication unit for the controller, and
the processor uses the obtained parameter information to control the power transmission for the battery.

2. The controller according to claim 1, wherein
the battery includes a battery using, as an active material, lithium manganese iron phosphate produced by recycling lithium-iron phosphate having been used as an active material, and
the parameter information includes information of a parameter used in the power transmission, that is preset based on a ratio between manganese and iron in the active material.

3. The controller according to claim 2, wherein the parameter information includes information of the preset parameter based on the ratio and an amount of impurities contained in the battery.

4. The controller according to claim 1, wherein
the controller is mounted on a vehicle, and
the processor performs the process to obtain the identification information when the vehicle has an ignition power supply turned on.

5. The controller according to claim 1, wherein
the controller is mounted on a vehicle, and
when the processor is connected to a terminal connectable to the vehicle, and receives a signal from the terminal to request the identification information, the processor responsively performs the process to obtain the identification information.

6. The controller according to claim 1, wherein when the identification information obtained is changed identification information, the communication unit for the controller sends the changed identification information to the external server.

7. A server provided outside the controller according to claim 1, comprising:
a communication unit for the server, that receives identification information of the battery; and
a storage unit that stores parameter information for a parameter for the power transmission conforming to the battery corresponding to the identification information, wherein
the communication unit for the server sends to the controller the parameter information conforming to the battery corresponding to the identification information received.

8. A control system comprising:
a controller that controls power transmission including at least one of charging a battery and discharging the battery; and
a server provided outside the controller,
the controller comprising:
a communication unit for the controller, that communicates with an external device; and
a processor that performs a process to obtain identification information of the battery, wherein
the external device includes an external server that stores parameter information for a parameter for the power transmission conforming to the battery corresponding to the identification information,
the processor obtains the parameter information conforming to the battery corresponding to the identification information from the external server through the communication unit for the controller, and
the processor uses the obtained parameter information to control the power transmission for the battery,
the server comprising:
a communication unit for the server, that receives identification information of the battery; and
a storage unit that stores parameter information for a parameter for the power transmission conforming to the battery corresponding to the identification information, wherein
the communication unit for the server sends to the controller the parameter information conforming to the battery corresponding to the identification information received.

9. A control method of a controller for controlling power transmission including at least one of charging a battery and discharging the battery, comprising:
obtaining identification information of the battery;
receiving from an external server that stores parameter information for a parameter for the power transmission conforming to the battery corresponding to the identification information the parameter information conforming to the battery corresponding to the identification information; and
controlling the power transmission for the battery using the parameter information received.

10. The control method according to claim 9, wherein
the battery includes a battery using, as an active material, lithium manganese iron phosphate produced by recycling lithium-iron phosphate having been used as an active material, and
the parameter information includes information of a parameter used in the power transmission, that is preset based on a ratio between manganese and iron in the active material.
